(19) United States
(12) Patent Application Publication
(10) Pub. No.: US 2003/0131112 A1
(43) Pub. Date: Jul. 10, 2003

(54) Computer firewall system

(75) Inventor: Roger Yu, Taipei (TW)

Correspondence Address: BACON & THOMAS, PLLC, 625 SLATERS LANE, FOURTH FLOOR, ALEXANDRIA, VA, 22314

(73) Assignee: Soyo Computer, Inc., Taipei Hsein (TW)

(21) Appl. No.: 10/035,127

(22) Filed: Jan. 4, 2002

(51) Int. Cl. G06F 15/16; G06F 11/30; G06F 12/14; H04L 9/32

(52) U.S. Cl. 709/229; 713/200

(57) ABSTRACT

The present invention relates to a computer firewall system, comprising an electronic erasable memory, a magnetic sector comparator, an interrupt output, and a firewall firmware, and being placed into a hard disk controller or in the internal circuit of the hard disk drive; the hard disk drive is divided into a plurality of partition areas, and the system monitors the data access of the partition areas by the program in order to prevent the operating system from being damaged and to protect the desired data or specific partition areas, thereby the users can feel ease to use the computer because the present invention has the function of minimizing the fear feeling of computer virus, computer hacker, unintentional delete, bad-intention delete, or data damage.

### BACKGROUND OF THE INVENTION

1. Field of the Invention

The present invention relates to a computer firewall system that divides a hard disk drive into several partition areas, and monitors the data access in the partition areas to prevent the operation system from being damaged and to protect the desired data or specific partition areas.

2. Description of the Prior Art

There are numerous kinds of computer viruses, and it is impossible to completely guard against the viruses. The main reason of the existence of computer viruses is the open architecture of computer platform technology. For example, after the IBM PC was introduced, it has already become a standard computer, and a vast majority of the personal computers in the world are IBM compatible. Therefore, many books about personal computer technology are all over the places, and most computer technologies taught in school are based on the IBM PC as standard computer.

Because of it, computer hackers are able to code virus programs to intrude computers by utilizing the foregoing open technology, and freely delete, amend, and damage data by intruding into other's computers, and even cause improper system operations or failures of the entire hard disk drive. It is always the largest threat to users. In recent years, due to the fast development of Internet, almost everyone in the world are logging in the Internet, and the hackers can use any transmission type by using Internet as a medium (such as email or data download from the network, etc) to spread viruses or intrude into computers, and anyone may be infected or intruded at any time.

Therefore, anti-virus programs are developed in the market, and new anti-virus programs constantly replace the old ones according to the types of new viruses. However, it is still impossible to catch up with the evolution speed of the viruses, since it is difficult to write a compatible and good program (anti-virus software or application software), and it is relatively much easier to code a compatible program (Virus program) that does not need to follow specifications.

Therefore the primary objective of the present invention is to provide a computer firewall system, comprising an electronic erasable memory, a partition area comparator, an interrupt output, and a firewall firmware being placed into a hard disk controller or in the internal circuit of the hard disk drive; the hard disk drive is divided into a plurality of partition areas, and the system monitors the data access of the partition areas by the program in order to prevent the operating system from being damaged and to protect the desired data or specific partition areas, thereby the users can feel ease to use the computer. The present invention has the function of minimizing the fear of computer virus, computer hacker, unintentional delete, bad-intention delete, or data damage.

Another objective of the present invention is to provide a computer firewall system that divides the hard disk drive into a write once partition area, a write warning partition area, and a free partition area, and the location data is recorded such that any access to the partition areas from the program at the system end is compared with the above mentioned location data; if it is a write once partition area, then the write warning partition area and the free partition area will completely refuse the access; or it will refuse the access first and after inputting the password for confirmation, then it is allowed to write the data; or let it access freely, and when it refuses to write in data or has the wrong password, it will simultaneously notice the firewall firmware by audio or video signals to inform the user. The computer users can feel ease to use the computer and the present invention minimizes the fear of computer virus, computer hacker, unintentional delete, and bad-intention delete.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is the block diagram showing each unit of the present invention.

FIG. 2 is the schematic diagram of the partition areas of the hard disk drive according to the present invention.

FIG. 3 shows the content of the electronic erasable memory according to the present invention.

### DETAILED DESCRIPTION OF THE PREFERRED EMBODIMENT

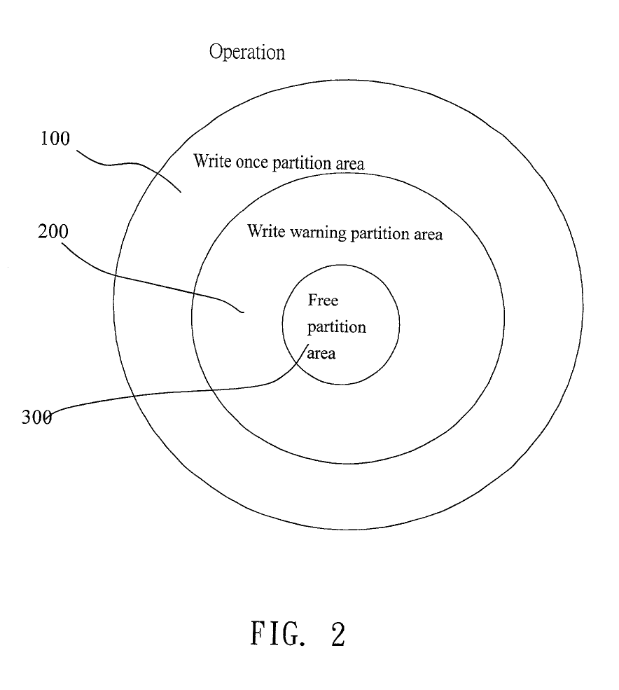

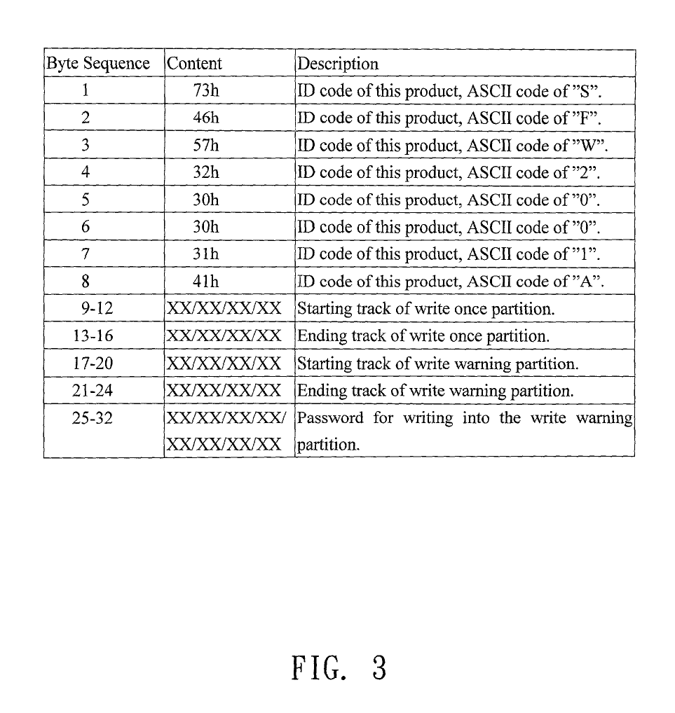

The present invention provides a computer firewall system. Please refer to FIG. 2. When a user has bought a new computer and before the operating system is installed, the user has to partition the hard disk drive. For example, if the capacity of the hard disk drive is 30 GB, and the hard disk drive is divided into three partition areas: an operating system area (write once partition area 100) of 5 GB, an application program area (write warning partition area 200) of 20 GB, and finally a data area (free partition area 300) of 5 GB. Further, the data of the starting and ending tracks then are written into a recording device (for example, electronic erasable memory). Please refer to FIG. 3.

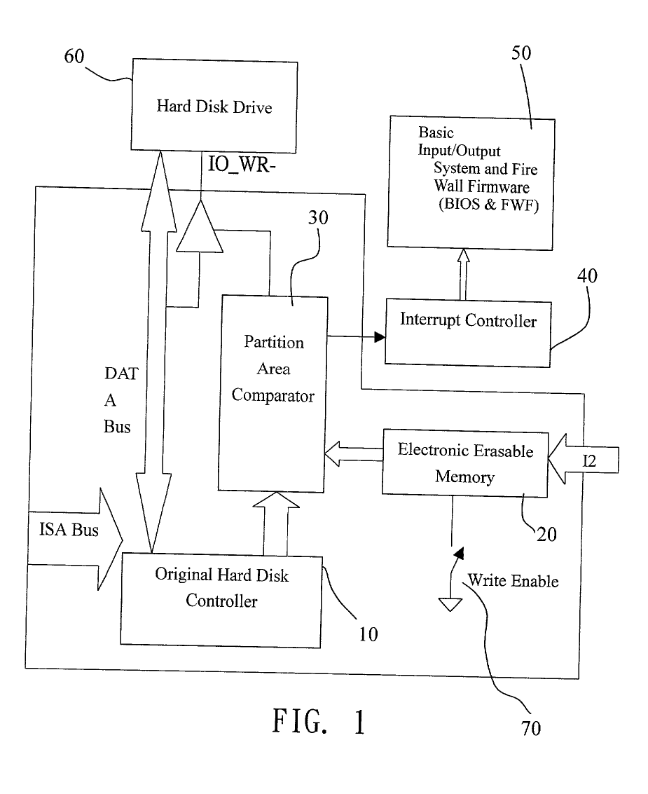

Please refer to FIG. 1. The present invention comprises an electronic erasable memory 20 being coupled to a partition area comparator 30, a partition area comparator being disposed between the original hard disk controller 10 and a hard disk drive 60, and a Basic Input/Output System and Fire Wall Firmware (BIOS & FWF) 50 with its end being serially coupled to a partition area comparator 30 and an interrupt controller 40.

In FIG. 1, the electronic erasable memory 20 is to record the partition area data of the write once partition area (operating system area) 100, the partition area data of the write warning partition area (application program area) 200, and password for entering into the write warning area 200. It only needs a memory of 23 bytes. Please refer to FIG. 3. Furthermore, the data write of the electronic erasable memory 20 is accomplished via the inter IC (I²C). In order to prevent the hacker to rewrite the content of the electronic erasable memory 20, a write disable pin 70 is added to the exterior of the electronic erasable memory 20. When the user wants to partition the hard disk drive again (such as updating the Windows operating system version), the user need to set the write enable jumper of the write protect pin 70. Therefore, unless the computer casing is opened, it is impossible to intrude into the computer for damage by software. Since such controllable write protect pin 70 needs to be reset first before any repartition, reinstallation, or update can be made. Even a user who wants to repartition the hard disk drive, reinstall or update the Windows operating system, the user must open the computer casing to set the jumper for the write disable pin 70.

As to the partition area comparator 30, it can automatic fetch the partition area data recorded in the electronic erasable memory 20 of the write once and write warning partition areas 100, 200, and compares the partition area data from the system end. If the partition area data come from the system end belongs to the area of the write once partition area 100 (operating system area), then it will disable the write in (IO_WR) signal and the hard disk drive interface, and output the interrupt to the interrupt controller 40.

If the partition area data come from the system end belongs to the area of the write warning partition 200 (application program area), then enable the interrupt generator, and the user determines whether or not to confirm writing in the data, and a password is needed to accomplish the confirmation.

If the electronic erasable memory 20 does not have any data, it means that the user does not protect the data in the hard disk drive, then it will operate as a regular computer, and the partition area comparator 30 no longer compare the partition area data.

As to the basic input/output system (BIOS) and the firewall firmware (FWF), the firewall firmware is used to process the interrupt request from the interrupt controller 40, and give warning to the user by means of displaying messages (audio or video). In fact, the firewall firmware is a modified program of the interrupt service in the BIOS only, and the interrupt serial number for the hard disk drive in personal computer is 14 (INT_14).

Please refer to FIGS. 1 and 2.

The write once partition area 100 is used to store the disk operating system or the Windows. After such write once area 100 is installed in the operating system, it becomes a read only partition area. Any program trying to rewrite the data in such area will be detected by a partition area comparator 30, and will be refused; and warning will be given.

Such partition area data (or location data) is written into the electronic erasable memory 20, and under the later computer operation, the partition area comparator 30 will from time to time compare such data (i.e. partition area data, or location data) and the partition area data (location data) come of the desired accessing partition area come from the system end. If they match, the signal of IO_WR-(write in) will be disabled, and an interrupt will be sent to notice the firewall firmware, and also notice and warn the user by sound or video display on the screen.

The foregoing write warning partition area 200 is used to store the application program. Any program tries to write in the partition area of the write warning partition area is warned, and the user has to confirm before any write in action is allowed. The confirmation methods includes three chances or any determined number of times of chance to input the correct password, otherwise it will refuse the data write action. In the meantime, the partition area comparator 30 will send an interrupt signal to notice the firewall firmware to warn the user by sound or screen display.

Such partition area also can serve as a backup area for the free partition area 300. The free partition area 300 is used to store application program or all kinds of data, and any program or data can be freely accessed. It is very similar to a regular hard disk drive, and is the only partition area that could be intruded.

The present invention is applicable to all kinds of computer and hard disk drive interface, ad the firewall system of the present invention is stored in the hard disk drive controller or the circuit in the hard disk drive of a personal computer such as Apples' I-Mac computer; furthermore it is also applicable for computers with regular IDE or SCSI hard disk drive interface. All it needs is to change the interrupt request signal to the DMA request signal. Of course, the firewall firmware should be stored in the DMA handler.

The firewall system of the present invention can be placed in the circuit of the hard disk drive, and the CPU in the hard disk drive will be in charge of all controls; of course, an electronic erasable memory is required inside the hard disk drive.

The electronic erasable memory 20 of the present invention is used to record specific partition area. It can use other storage device to accomplish the same function, for example, a flash memory or programmable array logic, etc; or even directly used BIOS to substitute it. However, the BIOS must also have the write protect function against unauthorized access.

The electronic erasable memory 20 of the present invention only uses 32 bytes to record the specific partition areas of a hard disk drive 60; of course larger memory capacity can record more partition areas and hard disk drives, or more types of partition areas.

Although the preferred embodiment of the present invention divides the hard disk drive 60 into a write once partition 100, a write warning partition area 200, and a free partition area 300, users can make adjustment according to their need. It means that the write once partition area 100 is not necessary to store operating system only, it can also be used to store application programs or data; in other words, the definition of partition area emphasizes on the method of data protection, but not on the content of data.

The present invention divides the hard disk drive 60 into several partition areas, and the scope of the partition area does not conflict with the so-called partition table of the hard disk drive. In other words, the starting track and the ending track of each partition in the partition table can be the same or different from the partition area of the present invention; each partition of the hard disk drive can even have several partition areas of the present invention. For simple application of the system, let the defined partition table be the same as the partition areas of the present invention.

The functions of the present invention are as follows:

1. It protects the operating system from being damaged. Regardless the program is through the Disk I/O handler of the BIOS, the operating system handler, or the DMA hard disk drive, the present invention can interrupt and refuse the writing of data and issue a warning.

2. The present invention reserves the free partition area 300 for free access of any program or data; when this partition area is damaged, the write warning partition area 200 can be used to restore the data. Although part of the new data in the free partition area 300 may be loss due to the virus, proper backup may minimize the damage.

3. Although the present invention needs additional logic circuit on the hard disk drive controller, it will not increase the cost due to the current IC integration and process.

In summation to the above description, the present invention provides a computer firewall system definitely can interrupt, refuse, and warn any attempt to write data into the write partition area in the operating system, and the application program and data in the write warning partition area. Besides protecting the data in the computer, the present invention lets the computer user use the computer with ease, and minimizes the fear for computer virus, computer hacker, unintentional delete, bad-intention delete, and data damage. The present invention meets the requirements of patentability, which is hereby submitted for patent application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

10 Original hard disk drive controller

20 Electronic erasable memory

30 Partition area comparator

40 Interrupt controller

50 Basic input/output system and firewall firmware (BIOS & FWF)

60 Hard disk drive

70 Write protect pin

100 Write once partition area

200 Write warning partition area

300 Free partition area

What is claimed is:

1. A computer firewall system, mainly dividing a hard disk drive into a plurality of partition areas, and the location of each partition area being recorded as a location data, and respectively defined as: a write once partition that can only be written in for one time and the partition area becomes read only thereafter, and any attempt to write in the partition area is warned and requested to confirm a write warning partition and a freely accessed free partition area; when a program at the system end accesses the partition area, a partition area comparator compares the location data; if the accessing partition area belongs to a write once partition area, then the write in signal of the hard disk drive is disabled, an interrupt signal is sent to notice the firewall firmware by audio or video to inform the user; if the accessing partition area belongs to the write warning partition area, then a warning is issued to request the user to input a password for confirmation, or else the system refuses the writing in of the data, and in the meantime the partition area comparator sends an interrupt signal to notice the firewall firmware by audio or video message to inform the user; if the accessing partition belongs to the free partition area, then the data can be freely accessed.

2. The computer firewall system as claimed in claim 1, wherein said location of the partition area recorded by a recording device may further have a write protect measure.

3. The computer firewall system as claimed in claim 2, wherein said write protect measure is accomplished by adding a write protect pin to the exterior of the recording device.

4. The computer firewall system as claimed in claims 1, 2, or 3, wherein said location data is recorded by a storage device selected from an electronic erasable memory, a flask memory, and a programmable array logic.

5. The computer firewall system as claimed in claims 1, 2, or 3, wherein said location data is recorded into the BIOS, and said BIOS has a write protect function against the rewrite by unauthorized person.

6. The computer firewall system as claimed in claims 1, 2, or 3, wherein said interrupt request signal is converted into a DMA signal, and the firewall firmware is stored in the DMA memory handler so that it can be used for IDE or SCSI hard disk drive interface.

7. The computer firewall system as claimed in claims 1, 2, or 3, wherein said firewall system is stored in the hard disk controller, and can further be stored in the circuit of the hard disk drive having a recording device for recording the location data.
